(19) United States
(12) Patent Application Publication
(10) Pub. No.: US 2023/0151824 A1
(43) Pub. Date: May 18, 2023

(54) MULTISTAGE COMPRESSOR WITH SWIRL-REDUCING RIBS

(71) Applicant: CARRIER CORPORATION, Palm Beach Gardens, FL (US)

(72) Inventors: Vishnu M. Sishtla, Syracuse, NY (US); Chaitanya Vishwajit Halbe, Hamden, CT (US)

(21) Appl. No.: 17/973,066

(22) Filed: Oct. 25, 2022

Related U.S. Application Data
(60) Provisional application No. 63/278,633, filed on Nov. 12, 2021.

(51) Int. Cl. F04D 29/44; F04D 17/06; F04D 25/06

(52) U.S. Cl. CPC F04D 29/444; F04D 17/06; F04D 25/0606

(57) ABSTRACT

An illustrative example embodiment of a multistage compressor includes a first compressor stage, a second compressor stage downstream of the first compressor stage, and a motor section between the first compressor stage and the second compressor stage. The motor section includes a housing and a motor within the housing. A space between the motor and the housing establishes a flow path for fluid to flow from the first compressor stage to the second compressor stage. A plurality of ribs within the space have a curvature along at least a portion of a length of the ribs that changes a direction of fluid flow within the space such that the fluid flows downstream of the curvature in a direction parallel to a longitudinal axis of the housing.

### CROSS REFERENCE TO RELATED APPLICATION

This application claims priority to U.S. Provisional Application No. 63/278,633, which was filed on Nov. 12, 2021.

### BACKGROUND

Compressors have various uses including, for example, refrigerant circuits useful for refrigeration or air conditioning. A variety of compressor designs are available. One type of compressor is referred to as a multistage compressor because it includes a first compressor stage upstream of a second compressor stage. Multistage compressors can introduce efficiencies and capabilities that exceed those of single-stage compressors. Even with the advantages a multistage compressor can provide, there are issues associated with fluid flow within the compressor especially between the first and second stages.

### SUMMARY

An illustrative example embodiment of a multistage compressor includes a first compressor stage, a second compressor stage downstream of the first compressor stage, and a motor section between the first compressor stage and the second compressor stage. The motor section includes a housing and a motor within the housing. A space between the motor and the housing establishes a flow path for fluid to flow from the first compressor stage to the second compressor stage. A plurality of ribs within the space have a curvature along at least a portion of a length of the ribs that changes a direction of fluid flow within the space such that the fluid flows downstream of the curvature in a direction parallel to a longitudinal axis of the housing.

In addition to one or more of the features described above, or as an alternative, the plurality of ribs respectively include a first portion and a second portion; the second portion is downstream of the first portion; the first portion has the curvature; and the second portion is parallel to the longitudinal axis.

In addition to one or more of the features described above, or as an alternative, the first compressor section forces fluid into the space along a trajectory that is at an oblique angle relative to the longitudinal axis of the housing; and the first portions of the ribs have a first segment situated at the oblique angle relative to the longitudinal axis.

In addition to one or more of the features described above, or as an alternative, the curvature of the first portion is configured to provide a smooth transition between the first segment and a terminal segment of the second portion.

In addition to one or more of the features described above, or as an alternative, the ribs at least partially extend between an interior of the housing and an exterior of the motor such that the ribs support the motor within the housing.

In addition to one or more of the features described above, or as an alternative, the plurality of ribs are equally spaced from each other in a circumferential direction.

In addition to one or more of the features described above, or as an alternative, the motor includes a rotor that rotates about the longitudinal axis.

An illustrative example embodiment of a method is for controlling fluid flow in a multistage compressor including a first compressor stage, a second compressor stage downstream of the first compressor stage, a housing between the first compressor stage and the second compressor stage, and a motor in the housing. The method includes directing fluid from the first compressor stage into a space between the housing and the motor; changing a direction of fluid within the space using a plurality of ribs within the space that include a curvature along at least a portion of a length of the ribs; and directing fluid flow downstream of the curvature in a direction parallel to a longitudinal axis of the housing.

In addition to one or more of the features described above, or as an alternative, the plurality of ribs respectively include a first portion and a second portion; the second portion is downstream of the first portion; the first portion has the curvature; and the second portion is parallel to the longitudinal axis.

In addition to one or more of the features described above, or as an alternative, the first compressor section forces fluid into the space along a trajectory that is at an oblique angle relative to the longitudinal axis of the housing; and the first portions of the ribs have a first segment situated at the oblique angle relative to the longitudinal axis.

In addition to one or more of the features described above, or as an alternative, the curvature of the first portion is configured to provide a smooth transition between the first segment and a terminal segment of the second portion.

In addition to one or more of the features described above, or as an alternative, the ribs at least partially extend between an interior of the housing and an exterior of the motor such that the ribs support the motor within the housing.

In addition to one or more of the features described above, or as an alternative, the plurality of ribs are equally spaced from each other in a circumferential direction.

In addition to one or more of the features described above, or as an alternative, the motor includes a rotor that rotates about the longitudinal axis.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 shows an example embodiment of a multistage compressor.

FIG. 2 shows an example configuration of ribs that support a motor within a housing of the multistage compressor of FIG. 1.

FIG. 3 schematically illustrates an example fluid flow pattern established by the ribs shown in FIG. 2.

### DETAILED DESCRIPTION

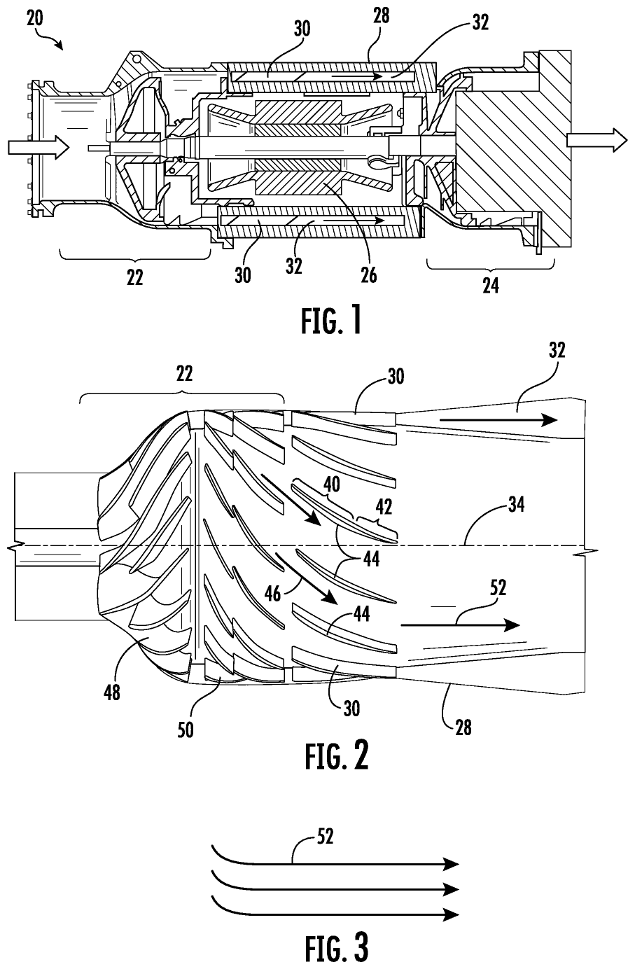

FIG. 1 schematically shows a multistage compressor 20 that includes a first compressor stage 22 and a second compressor stage 24 downstream of the first compressor stage 22. A motor 26, which causes rotation of rotating components of the compressor stages 22, 24 is situated between the first compressor stage 22 and the second compressor stage 24.

A housing 28 contains the motor 26 and is coupled with the compressor stages 22, 24. A plurality of ribs 30 extend in a radial direction from an inside of the housing 28 toward an exterior of the motor 26. In the illustrated example embodiment, the ribs 30 contact the exterior of the motor 26 and support the motor 26 within the housing 28. The ribs 30 have a height that corresponds to a difference between an outside dimension of the motor 26 and an inside dimension of the corresponding portion of the housing 28 along at least some of the length of the ribs. In some embodiments, the entire length of the ribs 30 corresponds to the radial distance between the interior of the housing 28 and the exterior of the motor 26.

The difference between the interior diameter or dimension of the housing 28 and the exterior of the motor 26 leaves a space 32 between the inside of the housing 28 and the outside or exterior of the motor 26. The space 32 provides a fluid flow path for fluid to flow from the first compressor stage 22 to the second compressor stage 24. The ribs 30 are equally spaced in a circumferential direction about the inside of the housing 28. The openings or spaces between the ribs 30 establish channels for the fluid to flow into and through the space 32.

The ribs 30 direct fluid flow through the space 32 in a manner that increases the efficiency of the multistage compressor 20. The ribs 30 each include a curvature along at least some of the length of the rib 30. The curvature of the ribs 30 changes a direction of fluid flow within the space 32 such that fluid downstream of the ribs 30 flows in a direction parallel to a longitudinal axis 34 of the housing 28.

As shown in FIG. 2, the ribs 30 respectively include a first portion 40 and a second portion 42. The first portions 40 in this example embodiment include the curvature as shown at 44. At least some of the second portion 42 in the illustrated example is oriented parallel to the longitudinal axis 34. In the illustrated example, the most downstream end of the ribs 30 are approximately parallel to the axis 34. The first compressor stage directs fluid into the space 32 along a trajectory that is at an oblique angle 46 relative to the longitudinal axis 34. This trajectory is the result of the operation of an impeller 48 and diffuser 50 of the first compressor stage.

The first portions 40 of the ribs 30 are at least partially oriented at approximately the oblique angle 46 relative to the axis 34. The curvatures 44 change the trajectory of the fluid and the second portions 42 guide or direct the fluid flow in a direction parallel to the axis 34.

With the ribs 30, fluid flowing through the space 30 follows a path or trajectory 52 like that schematically shown in FIG. 3. Without the ribs 30, the fluid flow along the entire length of the space 30 would include swirl. The fluid flow would follow a swirling or generally helical path. By changing the direction of the path 52 from a swirling or helical pattern to one that is parallel to the axis 34, the ribs 30 improve the efficiency of the multistage compressor 20.

Reducing or eliminating swirl along the space 32 reduces the wetted area and frictional losses as the fluid flows toward the second stage 24. This increases efficiency and allows for shortening the length of the multistage compressor 20, which allows for additional economic advantages. The configuration of the ribs 30 also eliminates any profile losses that may otherwise be caused by motor supporting ribs that are not aligned with the flow velocity direction.

Embodiments of this invention include ribs 30 that reduce or eliminate swirl of the fluid flowing downstream of the first compressor stage 22 through the space 32 toward the second compressor stage 24. The exact configuration of the ribs 30 may vary and those skilled in the art who have the benefit of this description will realize how to customize ribs consistent with those discussed above and shown in the drawings to meet the needs of their particular compressor design.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A multistage compressor, comprising:
a first compressor stage;
a second compressor stage downstream of the first compressor stage; and
a motor section between the first compressor stage and the second compressor stage, the motor section including a housing and a motor within the housing, a space between the motor and the housing establishing a flow path for fluid to flow from the first compressor stage to the second compressor stage, a plurality of ribs within the space include a curvature along at least a portion of a length of the ribs that changes a direction of fluid flow within the space such that the fluid flows downstream of the curvature in a direction parallel to a longitudinal axis of the housing.

2. The multistage compressor of claim 1, wherein
the plurality of ribs respectively include a first portion and a second portion;
the second portion is downstream of the first portion;
the first portion has the curvature; and
the second portion is parallel to the longitudinal axis.

3. The multistage compressor of claim 2, wherein
the first compressor section forces fluid into the space along a trajectory that is at an oblique angle relative to the longitudinal axis of the housing; and
the first portions of the ribs have a first segment situated at the oblique angle relative to the longitudinal axis.

4. The multistage compressor of claim 3, wherein the curvature of the first portion is configured to provide a smooth transition between the first segment and a terminal segment of the second portion.

5. The multistage compressor of claim 1, wherein the ribs at least partially extend between an interior of the housing and an exterior of the motor such that the ribs support the motor within the housing.

6. The multistage compressor of claim 1, wherein the plurality of ribs are equally spaced from each other in a circumferential direction.

7. The multistage compressor of claim 1, wherein the motor includes a rotor that rotates about the longitudinal axis.

8. A method of controlling fluid flow in a multistage compressor including a first compressor stage, a second compressor stage downstream of the first compressor stage, a housing between the first compressor stage and the second compressor stage, and a motor in the housing, the method comprising:
directing fluid from the first compressor stage into a space between the housing and the motor;
changing a direction of fluid within the space using a plurality of ribs within the space that include a curvature along at least a portion of a length of the ribs; and
directing fluid flow downstream of the curvature in a direction parallel to a longitudinal axis of the housing.

9. The method of claim 8, wherein
the plurality of ribs respectively include a first portion and a second portion;
the second portion is downstream of the first portion;
the first portion has the curvature; and
the second portion is parallel to the longitudinal axis.

10. The method of claim 9, wherein
the first compressor section forces fluid into the space along a trajectory that is at an oblique angle relative to the longitudinal axis of the housing; and
the first portions of the ribs have a first segment situated at the oblique angle relative to the longitudinal axis.

11. The method of claim 10, wherein the curvature of the first portion is configured to provide a smooth transition between the first segment and a terminal segment of the second portion.

12. The method of claim 8, wherein the ribs at least partially extend between an interior of the housing and an exterior of the motor such that the ribs support the motor within the housing.

13. The method of claim 8, wherein the plurality of ribs are equally spaced from each other in a circumferential direction.

14. The method of claim 8, wherein the motor includes a rotor that rotates about the longitudinal axis.
